(19) United States
(12) Patent Application Publication
(10) Pub. No.: US 2015/0199659 A1
(43) Pub. Date: Jul. 16, 2015

(54) SYSTEMS AND METHODS FOR TICKET CHECK-IN AND TRACKING

(71) Applicant: StubHub, Inc., San Francisco, CA (US)

(72) Inventor: Suzy Kyunghi Chang, San Jose, CA (US)

(21) Appl. No.: 14/152,956

(22) Filed: Jan. 10, 2014

(51) Int. Cl. G06Q 20/04; G06Q 30/06

(52) U.S. Cl. CPC G06Q 20/045; G06Q 30/0601

(57) ABSTRACT

A scannable code may be generated for a seller using last minute services (LMS) of an online ticket server. The scannable code can be generated by a ticket server or a last minute services server and provided to the seller together with instructions to send or deliver the tickets to a particular last minute services center. When the tickets are received at the last minute services center, the scannable code can be scanned using a code scanner at the last minutes services center. In response to receiving the scanned scannable code, a ticket listing on the online ticket server may be activated or otherwise updated. Once the scannable code has been received by the system, the scannable code can be used to track the movement and status of the tickets during a ticket listing, sale, and purchase operation.

### BACKGROUND

1. Technical Field

The present disclosure relates generally to electronic commerce, and more particularly, to systems and methods for facilitating last minute selling and buying of tickets for ticketed events.

2. Related Art

Computer systems and networks have facilitated the tasks of buying, selling and transferring goods. For example, global computer networks, such as the Internet, have allowed purchasers to relatively quickly and efficiently seek and purchase goods online. Similarly, global computer networks provide an efficient and cost-effective medium for sellers to advertise, offer, provide, and sell their goods. Electronic commerce companies provide buyers and sellers with online services and the infrastructure to accept orders of goods from remote purchasers, to perform the financial transactions necessary to confirm and complete the sale of goods, to ship or distribute the goods to remote purchasers, and to perform other related logistics.

One example of a market for goods within the realm of electronic commerce is the online ticket market. Various online ticket sellers provide websites through which parties can buy and sell tickets online. These tickets can be obtained by a user to reserve seats and/or admission for a variety of live events, such as sporting events, concerts, theater events, and other entertainment events. Typically, a buyer looks for available tickets on a ticket marketplace website or other online listing and decides which, if any, of the available tickets are of interest to the buyer for possible purchase.

In some cases, an online ticket seller will also provide a physical brick-and-mortar store front to facilitate ticket sales at or near the start time of an event. A selling party drops off tickets that they wish at sell to the online ticket seller's store front and a buyer can picks up the physical ticket for the event at the store front. However, because of the wide variety of ticket types, source vendors, delivery methods and times, and other factors, if care is not taken, confusion can arise in connection with the online listing and physical delivery of tickets that can negatively affect the efficient sale and purchase of tickets and thereby reduce the attendance at ticketed events.

It may therefore be desirable to provide improved systems and methods for buying and selling of tickets for various ticketed events.

### BRIEF DESCRIPTION OF THE DRAWINGS

FIG. 1 is a block diagram of an illustrative computing system that is adapted for implementing the sale and purchase of tickets for ticketed events according to an embodiment.

FIG. 2 is a block diagram of an illustrative computer system suitable for implementing on one or more devices of the computing system in FIG. 1 according to an embodiment.

FIG. 3 is a block diagram of an illustrative system for facilitating the sale, purchase, and tracking of tickets for ticketed events according to an embodiment.

FIG. 4 diagram of a bar code that may be provided to a seller having tickets for sale according to an embodiment.

FIG. 5 is a diagram of an illustrative last minute services center having a code scanner according to an embodiment.

FIG. 6 is a flowchart of an illustrative process that may be performed for tracking ticket listing and status activity using scannable codes according to an embodiment.

FIG. 7 is a flowchart showing an illustrative process that may be performed for preventing ticket listing errors using a scannable code associated with the tickets according to an embodiment.

### DETAILED DESCRIPTION

Exemplary applications of apparatuses and methods according to the present invention are described in this section. These examples are being provided solely to add context and aid in the understanding of the invention. It will thus be apparent to one skilled in the art that the present invention may be practiced without some or all of these specific details. In other instances, well known process steps have not been described in detail in order to avoid unnecessarily obscuring the present invention. Other applications are possible, such that the following examples should not be taken as limiting.

In the following detailed description, references are made to the accompanying drawings, which form a part of the description and in which are shown, by way of illustration, specific embodiments of the present invention. Although these embodiments are described in sufficient detail to enable one skilled in the art to practice the invention, it is understood that these examples are not limiting, such that other embodiments may be used, and changes may be made without departing from the spirit and scope of the invention.

Devices, systems and methods are provided for performing activities related to the online sale, purchase, and resale of tickets to ticketed events. In various particular embodiments, the devices, systems or methods can involve one or more devices in communication over a network. Such devices, systems, and methods can facilitate the sale and purchase of tickets to various ticketed events. In some embodiments, the sale and purchase of tickets may be facilitated by tracking activities associated with a ticket listing while the associated ticket or set of tickets is listed for sale (e.g., by generating a scannable code for each ticket or set of tickets). Activity associated with the location and movement of physical tickets (e.g., ticket status activity) can be monitored and logged using the scannable code in order to prevent and/or correct potential errors in the ticket sale and/or purchase process.

While the various examples disclosed herein focus on particular aspects regarding the online sale and/or purchase of tickets, it will be understood that the various inventive principles and embodiments disclosed herein can be applied to other types of ticketed applications and arrangements as well. For example, a ticket purchase that is performed in person or on a closed or proprietary computing system may utilize one or more of the aspects and features found in the various systems and methods provided.

Reference throughout the specification to “various embodiments,” “some embodiments,” “one embodiment,” “an embodiment,” “various examples,” “one example,” “an example,” or “some examples” means that a particular feature, structure, or characteristic described in connection with the embodiment or example is included in at least one embodiment. Thus, appearances of these are not necessarily all referring to the same embodiment. Furthermore, the particular features, structures or characteristics may be combined in any suitable manner in one or more embodiments.

According to an embodiment, a computer program product can comprise a non-transitory machine readable medium. The non-transitory machine readable medium can have computer readable and executable code for instructing one or more processors to perform any of the methods disclosed herein.

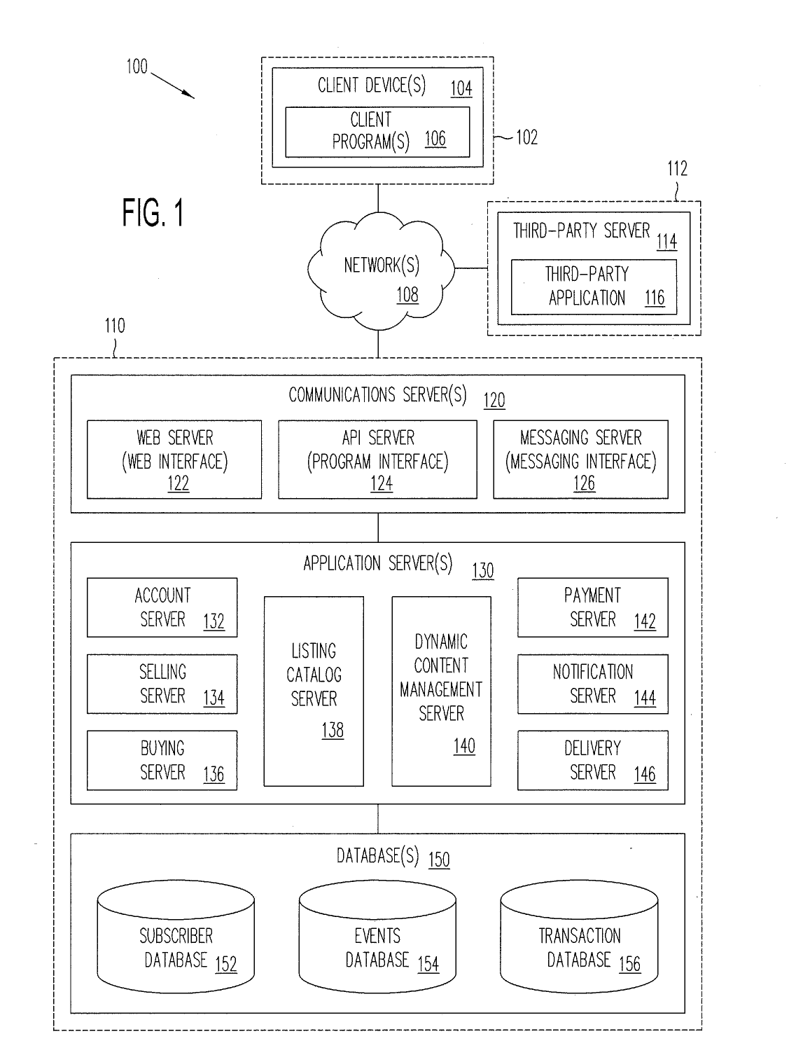

Beginning with FIG. 1, an exemplary embodiment of a computing system adapted for implementing the sale and purchase of tickets for ticketed events is illustrated in block diagram format. As shown, a computing system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

Computing system 100 can include, among various devices, servers, databases and other elements, a client 102 that may comprise or employ one or more client devices 104, such as a laptop, a mobile computing device, a PC, and/or any other computing device having computing and/or communications capabilities in accordance with the described embodiments. In particular, it is specifically contemplated that client devices 104 can include a cellular telephone or other similar mobile device that a user can carry on or about his or her person and access readily.

Client devices 104 generally may provide one or more client programs 106, such as system programs and application programs to perform various computing and/or communications operations. Exemplary system programs may include, without limitation, an operating system (e.g., MICROSOFT® OS, UNIX® OS, LINUX® OS, Symbian OS™, Embedix OS, Binary Run-time Environment for Wireless (BREW) OS, JavaOS, a Wireless Application Protocol (WAP) OS, and others), device drivers, programming tools, utility programs, software libraries, application programming interfaces (APIs), and so forth. Exemplary application programs may include, without limitation, a web browser application, messaging applications (e.g., e-mail, IM, SMS, MMS, telephone, voicemail, VoIP, video messaging), contacts application, calendar application, electronic document application, database application, media application (e.g., music, video, television), location-based services (LBS) application (e.g., GPS, mapping, directions, point-of-interest, locator), and so forth. One or more of client programs 106 may display various graphical user interfaces (GUIs) to present information to and/or receive information from one or more of client devices 104.

As shown, client 102 can be communicatively coupled via one or more networks 108 to a network-based system 110. Network-based system 110 may be structured, arranged, and/or configured to allow client 102 to establish one or more communications sessions with network-based system 110 using various computing devices 104 and/or client programs 106. Accordingly, a communications session between client 102 and network-based system 110 (e.g., a communications session for selection, sale, and/or purchase of tickets for a ticketed event) may involve the unidirectional and/or bidirectional exchange of information and may occur over one or more types of networks 108 depending on the mode of communication. While the embodiment of FIG. 1 illustrates a computing system 100 deployed in a client-server operating environment, it is to be understood that other suitable operating environments and/or architectures may be used in accordance with the described embodiments.

Data and/or voice communications between client 102 and the network-based system 110 may be sent and received over one or more networks 108 such as the Internet, a WAN, a WWAN, a WLAN, a mobile telephone network, a landline telephone network, a VoIP network, as well as other suitable networks. For example, client 102 may communicate with network-based system 110 over the Internet or other suitable WAN by sending and or receiving information via interaction with a web site, e-mail, IM session, and/or video messaging session. Any of a wide variety of suitable communication types between client 102 and system 110 can take place, as will be readily appreciated. In particular, wireless communications of any suitable form may take place between client 102 and system 110, such as that which often occurs in the case of mobile phones or other personal mobile devices.

In various embodiments, computing system 100 can include, among other elements, a third party 112, which may comprise or employ a third-party server 114 hosting a third-party application 116. In various implementations, third-party server 114 and/or third-party application 116 may host a web site associated with or employed by a third party 112. For example, third-party server 114 and/or third-party application 116 may enable network-based system 110 to provide client 102 with additional services and/or information, such as additional ticket inventory. Third-party server 114 and/or third-party application 116 may provide system 110 and/or client 102 with email services and/or information, social networking services and/or information, purchase services and/or information, or other online services and/or information.

In some embodiments, one or more of client programs 106 may be used to access network-based system 110 via third party 112. For example, client 102 may use a web client to access and/or receive content from network-based system 110 after initially communicating with a third-party web site 112.

Network-based system 110 may comprise one or more communications servers 120 to provide suitable interfaces that enable communication using various modes of communication and/or via one or more networks 108. Communications servers 120 can include a web server 122, an API server 124, and/or a messaging server 126 to provide interfaces to one or more application servers 130. Application servers 130 of network-based system 110 may be structured, arranged, and/or configured to provide various online marketplace and/or ticket fulfillment services to users that access network-based system 110. In various embodiments, client 102 may communicate with applications servers 130 of network-based system 110 via one or more of a web interface provided by web server 122, a programmatic interface provided by API server 124, and/or a messaging interface provided by messaging server 126. It can be appreciated that web server 122, API server 124, and messaging server 126 may be structured, arranged, and/or configured to communicate with various types of client devices 104 and/or client programs 106 and may interoperate with each other in some implementations.

Web server 122 may be arranged to communicate with web clients and/or applications such as a web browser, web browser toolbar, desktop widget, mobile widget, web-based application, web-based interpreter, virtual machine, and so forth. API server 124 may be arranged to communicate with various client programs 106 and/or a third-party application 116 comprising an implementation of API for network-based system 110. Messaging server 126 may be arranged to communicate with various messaging clients and/or applications such as e-mail, IM, SMS, telephone, VoIP, video messaging, and so forth, and messaging server 126 may provide a messaging interface to enable access by client 102 and/or third party 112 to the various services and functions provided by application servers 130.

When implemented as an online ticket marketplace, application servers 130 of network-based system 110 may provide various online marketplace and ticket fulfillment services including, for example, account services, buying services, selling services, listing catalog services, delivery services, payment services, gathering services, location-based services, code-generation services, tracking services, and notification services. Application servers 130 may include an account server 132, a selling server 134, a buying server 136, a listing catalog server 138, a dynamic content management server 140, a payment server 142, a notification server 144, and/or a delivery server 146 structured and arranged to provide such online marketplace and ticket fulfillment services.

Application servers 130, in turn, may be coupled to and capable of accessing one or more databases 150 including a subscriber database 152, an active events database 154, and/or a transaction database 156. Databases 150 generally may store and maintain various types of information for use by application servers 130 and may comprise or be implemented by various types of computer storage devices (e.g., servers, memory) and/or database structures (e.g., relational, object-oriented, hierarchical, dimensional, network) in accordance with the described embodiments.

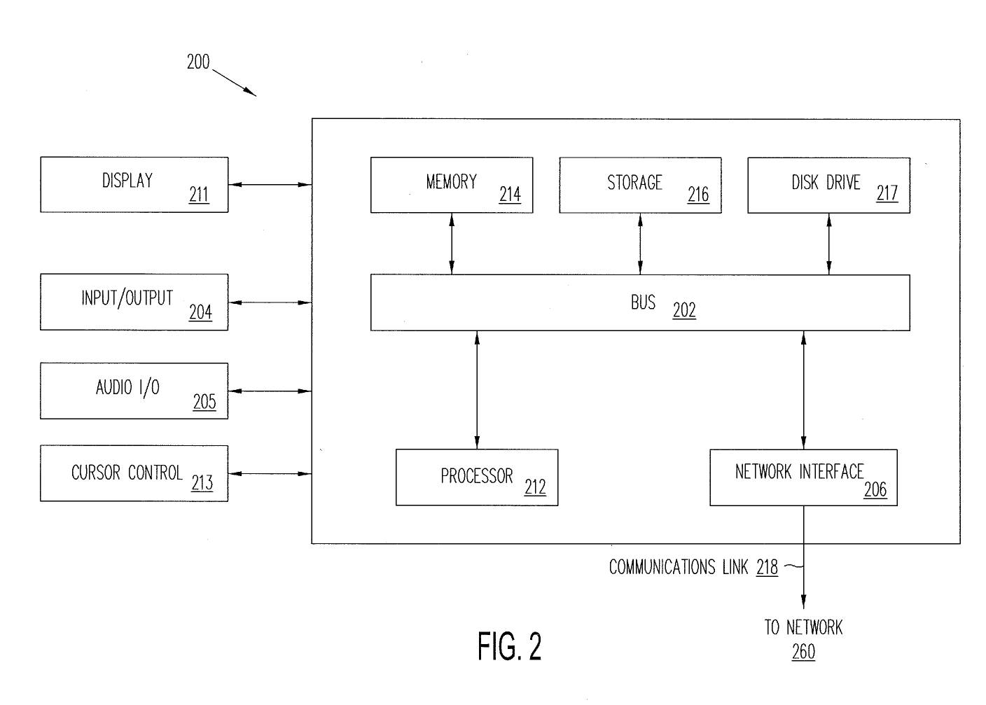

Continuing with FIG. 2, an exemplary computer system 200 suitable for implementing on one or more devices of the computing system in FIG. 1 is depicted in block diagram format. In various implementations, a device that includes computer system 200 may comprise a personal computing device (e.g., a smart or mobile phone, a computing tablet, a personal computer, laptop, PDA, Bluetooth device, key FOB, badge, etc.) that is capable of communicating with a network. The ticket provider and/or a payment provider may utilize a network computing device (e.g., a network server) capable of communicating with the network. It should be appreciated that each of the devices utilized by users, ticket providers, and payment providers may be implemented as computer system 200 in a manner as follows.

Computer system 200 can include a bus 202 or other communication mechanism for communicating information data, signals, and information between various components of computer system 200. Components include an input/output (I/O) component 204 that processes a user action, such as selecting keys from a keypad/keyboard, selecting one or more buttons or links, etc., and sends a corresponding signal to bus 202. I/O component 204 may also include an output component, such as a display 211 and a cursor control 213 (such as a keyboard, keypad, mouse, etc.). An optional audio input/output component 205 may also be included to allow a user to use voice for inputting information by converting audio signals. Audio I/O component 205 may allow the user to hear audio. A transceiver or network interface 206 transmits and receives signals between computer system 200 and other devices, such as another user device, a merchant server, a venue server, an email server, a social networking server, a logging server, a last minute services server, a customer services server, other third-party servers, and/or a payment provider server via a network. In various embodiments, such as for many cellular telephone and other mobile device embodiments, this transmission can be wireless, although other transmission mediums and methods may also be suitable. A processor 212, which can be a micro-controller, digital signal processor (DSP), or other processing component, processes these various signals, such as for display on computer system 200 or transmission to other devices over a network 260 via a communication link 218. Again, communication link 218 can simply be a wireless communication form in some embodiments. Processor 212 may also control transmission of information, such as cookies or IP addresses, to other devices.

Components of computer system 200 also include a system memory component 214 (e.g., RAM), a static storage component 216 (e.g., ROM), and/or a disk drive 217. Computer system 200 performs specific operations by processor 212 and other components by executing one or more sequences of instructions contained in system memory component 214. Logic may be encoded in a computer readable medium, which may refer to any medium that participates in providing instructions to processor 212 for execution. Such a medium may take many forms, including but not limited to, non-volatile media, volatile media, and transmission media. In various implementations, non-volatile media includes optical or magnetic disks, volatile media includes dynamic memory, such as system memory component 214, and transmission media includes coaxial cables, copper wire, and fiber optics, including wires that comprise bus 202. In one embodiment, the logic is encoded in non-transitory machine-readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 200. In various other embodiments of the present disclosure, a plurality of computer systems 200 coupled by communication link 218 to the network (e.g., such as a LAN, WLAN, PTSN, and/or various other wired or wireless networks, including telecommunications, mobile, and cellular phone networks) may perform instruction sequences to practice the present disclosure in coordination with one another. Modules described herein can be embodied in one or more computer readable media or be in communication with one or more processors to execute or process the steps described herein.

A computer system may transmit and receive messages, data, information and instructions, including one or more programs (i.e., application code) through a communication link and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Such software may be stored and/or used at one or more locations along or throughout the system, at client 102, network-based system 110, or both. Where applicable, the ordering of various steps described herein may be changed, combined into composite steps, and/or separated into sub-steps to provide features described herein.

The foregoing networks, systems, devices, and numerous variations thereof can be used to implement a ticket listing, tracking, sale, and/or purchase operation according to various embodiments.

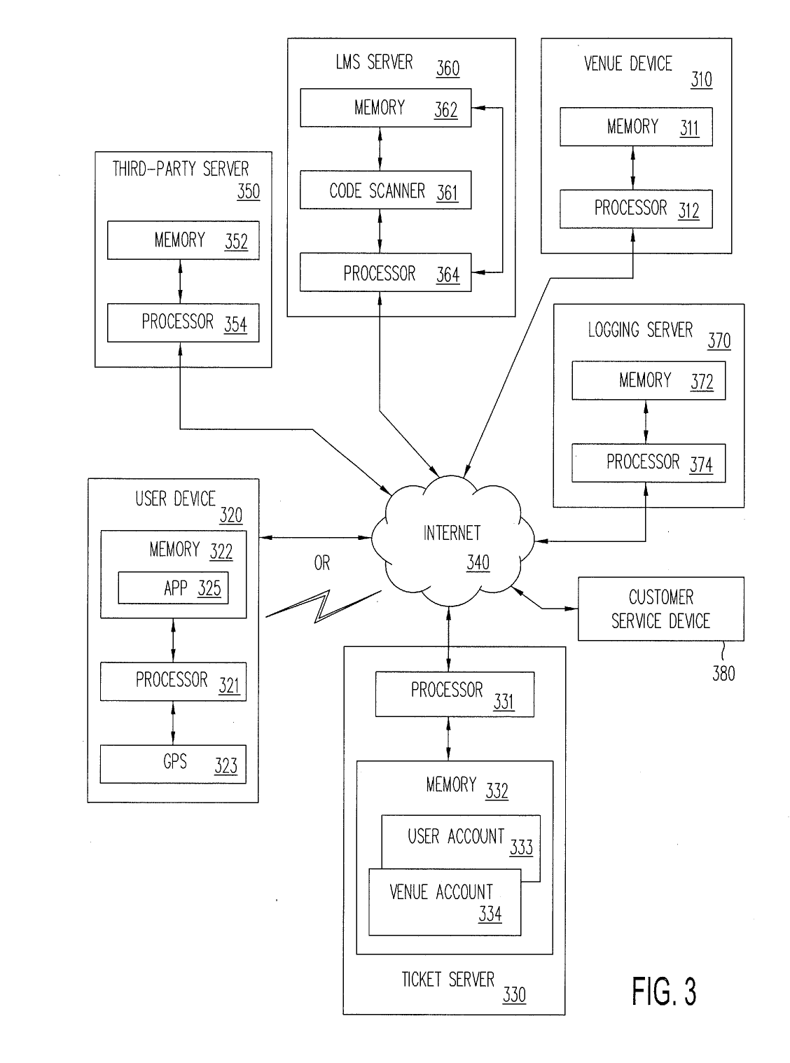

FIG. 3 is a block diagram showing a ticket sale, tracking, purchase, and fulfillment system that may be used to provide ticket listing services, listing tracking services, code-generation services, ticket tracking services, ticket purchase services, ticket fulfillment services, last minute services (LMS), and/or ticket-related customer service according to an embodiment. As shown in FIG. 3, a ticket server 330 may be in communication with one or more user devices such as user device 320, one or more venue devices such as venue device 310, one or more third-party servers such as third-party server 350, one or last minute services (LMS) servers such as LMS server 360, one or more logging servers such as logging server 370, and/or one or more customer service devices such as customer service device 380.

A user (e.g., a potential ticket buyer, a ticket buyer, or a ticket seller) can use a device such as a user device 320 to shop online for available tickets for one or more events, to select and purchase tickets for ticketed events from ticket server 330, to sell tickets for ticketed events, and/or to determine the status of a ticket listing and/or a ticket (as examples).

User device 320 can be a mobile device such as a cellular telephone, a tablet computer, a laptop computer, or another portable computing device. User device 320 can be a non-mobile device such as a home (land line) telephone, a desktop computer, an interactive set top box, or the like. User device 320 can be any device or combination of devices that facilitate online ticket purchasing. User device 320 may, for example, be an implementation of client device 104 of FIG. 1.

User device 320 can have a processor 321, a memory 322, a global positioning system component (GPS) 323 and/or other suitable device components. Processor 321 can execute an application such as an app 325 that facilitates the ticket sales, selection and/or purchase methods disclosed herein. App 325 can be stored in memory 322. App 325 can provide a graphical user interface (GUI) for the user when the user is selling, selecting, tracking, and/or purchasing tickets online. If desired, app 325 can be a dedicated ticket marketplace app. However, this is merely illustrative. In some configurations, app 325 can be part of another app, such as a Paypal, Inc. payment provider app.

User device 320 can communicate with venue device 310, third-party server 350, LMS server 360, customer service device 380, and/or ticket server 330 via a network. For example, user device 320 can communicate with venue device 310, third-party server 350, LMS server 360, customer service device 380, and/or ticket server 330 via the Internet 340. User device 320 can communicate with the Internet via either a wired connection or a wireless connection. App 325 may be configured to transmit to ticket server 330 location information of user device 320 and/or ticket listing, tracking, buying, and/or selling information. In some embodiments, ticket server 330 may have access to location information for a user based on location data from GPS 323.

Ticket server 330 may be operated by an online ticket seller such as StubHub, Inc. Ticket server 330 can facilitate online ticket sales. Ticket server 330 may include processing circuitry such as a processor 331 in communication with storage such as a memory 332. Processor 331 can include one or more processors. Processor 331 can access accounts such as a user account 333 and/or a venue account 334 that are stored in memory 332. User account 333 can include information regarding the user (e.g., identification information, preferences, account numbers, purchase history, social network contacts, email contacts, email account permissions, social media account permissions, purchased-ticket event information, attended event information, listing information, etc.). Venue account 334 can include information regarding the venue (e.g., information regarding events, seating, venue location, and other venue features). Memory 332 can be separate from the ticket server and can be used to store any number of user accounts 333, venue accounts 334, or other information for facilitating selling, tracking, and buying of tickets. Memory 332 can be distributed, e.g., have portions thereof disposed at a plurality of different locations. Other accounts may also be accessible by processor 331, such as accounts of users selling tickets that include ticket listing details, such as price, quantity, location, event information, and user information such as financial information that enables funds to be deposited into seller accounts when their tickets are sold.

Ticket server 330 may include one or more servers located at one or more locations. Thus, the ticket server 330 can be geographically and operationally distributed if desired. Ticket server 330 can be part of another system, such as a payment provider system.

Ticket server 330 can communicate with LMS server 360, logging server 370, and/or customer service device 380 over a wired or wireless connection such as via a network. For example, ticket server 330 can communicate with LMS server 360, logging server 370, and/or customer service device 380 via Internet 340.

Logging server 370 may be separate from ticket server 330 or may form a portion of ticket server 330. Logging server 370 may include computing equipment such as processor 374 and/or memory 372. Memory 372 and processor 374 may generate, store, and/or maintain a listing log associated with each ticket and/or set of tickets that are listed for sale using ticket server 330. For example, when a seller lists a ticket for sale using ticket server 330, ticket server 330 may transmit listing information to logging server 370. Logging server 370 may generate a listing log for that listing that includes the listing creating date, an identity of the seller, and/or other information associated with the listing. When the listing is updated (e.g., by the seller, by the ticket server, by LMS server 360, customer service device 380 and/or third party server 350), ticket server 330 may transmit listing update metadata to logging server 370 that can be aggregated and stored in order to track the status and changes to the status of a listing.

LMS server 360 may be a server of a last minute services affiliate of ticket server 330. LMS server 360 may be located remotely from ticket server 330 or may be partially or completely incorporated in ticket server 330. In one embodiment, an LMS server such as LMS server 360 may be located at a last minute services location that facilitates delivery of tickets of ticket sales that occur close to the start time of an associated ticketed event.

It can be appreciated that both sellers and buyers of tickets may desire the last available sale time to be as close to the event start time as possible in order to maximize the opportunity to make a sale and the opportunity to witness an event. Accordingly, the ticket server 330 and LMS server 360 may cooperate to provide sellers and buyers with various last minute services (LMS) for maintaining an event listing and the ability to sell and purchase listed tickets right up to the start of the event.

In one implementation, for example, ticket server 330 and LMS server 360 may allow tickets to be sold on consignment and may maintain an event listing until the start of the event. When a seller requires delivery of physical tickets for an upcoming event, the seller may select to sell the tickets using LMS provided by the ticket server 330 and LMS server 360. The seller may request LMS and provide the ticket server 330 and/or LMS server 360 with contact information (e.g., name, address, telephone number, e-mail address), ticket information (e.g., event name, event venue, ticket event dates, closest city to the event), and authorization to release the tickets.

In response to the LMS request, the seller may be contacted by an agent of ticket server 330 and/or LMS server 360 via telephone or other contact method and provided with additional selling information. Depending on the time remaining before the event, the seller may be instructed to ship or physically deliver the tickets to an LMS center associated with LMS server 360. Typically, the location of the LMS center will be in close proximity to the event venue. The seller also may select to physically deliver the tickets to the LMS center. When physical delivery of the ticket to the LMS center is required or selected, the seller may be provided with the location of the LMS center, driving or walking directions to the LMS center, and/or a map showing the LMS center.

The LMS center (e.g., using LMS server 360) and/or the ticket server may generate a scannable code such as a bar code, a quick response (QR) code or other scannable code for each ticket or set of tickets when LMS is requested. The scannable code may be provided to the seller by LMS server 360, by an agent of an LMS center, by ticket server 330, or by physical delivery (as examples). In one embodiment, a bar code may be automatically generated by LMS server 360 and electronically transmitted to a user device of the seller. The LMS center and/or the ticket server may also provide the seller with instructions to include the scannable code with the tickets when the tickets are shipped and/or delivered to the LMS center. The scannable code may be provided to the seller electronically in a format that can be printed by the seller, using the seller's own printer or the scannable code may be physically mailed or delivered to the seller.

Once the tickets are delivered to the LMS center, a code scanner such as code scanner 361 may be used to read the scannable code. Code scanner 361 may be incorporated in LMS server 360 or may be located separately from LMS server 360 and communicatively coupled to LMS server 360 and/or ticket server 330.

In response to receiving the scanned code, LMS server 360 may instruct ticket server 330 to activate and/or maintain an associated event listing until the start of the event and/or until the subsequent delivery of the tickets to a buyer is handled by the LMS center. In this way, delays in activating a ticket listing due to wait times associated with mail delivery, mail opening, and/or agent availability can be avoided. Errors associated with an unknown ticket location and status can also be avoided.

Moreover, because an LMS center and/or a ticket server such as ticket server 330 may handle the resale of tickets originally generated by a wide variety of ticket vendors, event venues, event coordinators, or other sources of tickets for ticketed events, a scannable code generated and provided by an LMS center and/or a ticket server for a seller of previously purchased tickets can facilitate the tracking of tickets of any size, shape, and format from any suitable ticket source.

In some embodiments, code scanner 361 may be available for code scanning by the seller. For example, code scanner 361 may be available in the lobby of an LMS center, on an exterior portion of an LMS center, or within an automated ticket acceptance device at an LMS center so that, even when no LMS agent is available (e.g., after opening hours, on holidays or weekends, etc.), tickets can be delivered and listings can be activated without delay. In some embodiments, the tickets themselves can also be imaged at the LMS center for further verification and tracking purposes. One or more images of the tickets can be added the ticket listing.

The LMS center may handle the responsibility of shipping the tickets to the buyer, delivering the tickets to the event venue will call, and/or the keeping the tickets at the LMS center until pick-up by the buyer. The scannable code associated with the ticket listing can be scanned (read) each time a new action (e.g., shipping to a buyer, delivery to the event venue will call, pick-up by the buyer) is taken with the tickets. In this way, the status of the tickets can be tracked and determined at any time during the ticket sale and purchase operation.

LMS server 360 may include processing circuitry such as processor 364 and storage such as memory 362. LMS server 360 may provide ticket status updates to ticket server 330 and/or logging server 370. For example, when an LMS center (e.g., using LMS server 360) provides ticket delivery information to a user, receives tickets from a user, generates a scannable code associated with one or more tickets and/or listings, scans a bar code associated with one or more tickets and/or listings, and/or provides tickets to a buyer (as examples), LMS server 360 can transmit ticket status metadata describing that ticket activity to logging server 370 for storage and tracking (e.g., in a listing log) on the logging server. Each time the scannable code is scanned, an update may be provided to ticket server 330. Ticket status updates associated with a scanned code and/or an imaged ticket (e.g., the time stamp and/or location of a scanned code and/or the image of the ticket) can be added to a ticket listing on ticket server 330 for viewing by the seller, a potential buyer or a buyer.

It can be appreciated that the LMS including scannable code generation provided by the ticket server 330 and LMS server 360 may facilitate delivery and allow ticket server 330 and LMS server 360 to defer the last sale time until the start of the event.

Customer service device 380 may be any suitable device that can be used by a customer service center and/or customer service representative to handle customer service communications with buyers and sellers and/or access ticket listing information and/or ticket status information stored by logging server 370. For example, when a seller contacts a customer service center to inquire about the status of a listing and/or tickets of the seller, a customer service agent and/or automated customer service device can use a computer, a smart phone, a tablet, or other suitable customer service device to look up the status and history of a listing and/or a ticket as tracked by a scannable code associated with the ticket and/or the seller.

Venue device 310 and/or third-party server 350 can communicate with ticket server 330 over a wired or wireless connection such as via a network. For example, venue device 310 and/or third-party server 350 can communicate with ticket server 330 via Internet 340. Venue device 310, LMS server 360, logging server 370, customer service device 380, and/or third-party server 350 can communicate with a plurality of different ticket servers 330. Ticket server 330 can communicate with a plurality of different venue devices 310, LMS servers 360, logging servers 370, customer service devices 380, and/or third-party servers 350. A plurality of different ticket servers 330 can communicate among themselves and can be considered herein as being the same as a single ticket server 330.

Ticket server 330 can communicate with venue device 310 to obtain information about the venue. For example, ticket server 330 can communicate with venue device 310 to obtain information regarding the scheduling of events at the venue and regarding features of the venue. The features of the venue can be dependent upon the events of the venue, e.g., the features of the venue can vary from event to event.

Venue device 310 can be a computer, a server, a computing tablet, or a mobile device, as examples. Venue device 310 can have processing circuitry such as processor 312 and storage such as memory 311. Processor 312 can execute a software program stored in memory 311 for providing information regarding events scheduled to be at the venue and regarding seating at the venue for each scheduled event. Venue device 310 can provide the information to the ticket server, to LMS server 360, and/or to a user device such as user device 320.

Third party servers such server 350 may include, for example, a social media server that hosts one or more social networking accounts (e.g., a social networking account for a user of user device 320) and/or an email server that hosts email services (e.g., an email account for the user). A user may use user device 320 to access a social networking site that is hosted by one of servers 350, to send, store, and receive emails or other electronic communications on an email account that is hosted by one of servers 350, and/or to access other services on one of servers 350. Third party server 350 can be a computer, a server, a computing tablet, or a mobile device, as examples. Server 350 can have processing circuitry such as processor 354 and storage such as memory 352.

In one embodiment, servers 350 and/or 310 can be omitted if ticket server 330 has the information needed for buying, tracking, and selling of tickets. For example, ticket server 330 may have a database of available tickets and information about the tickets and venues that enables ticket server 330 to provide the necessary information to a user for selling and/or purchasing tickets to events at venues.

Generally, venue device 310, user device 320, third-party server 350, LMS server 360, logging server 370, customer service device 380, and ticket server 330 can perform functions discussed herein. That is, at least to some extent, a function that is discussed herein as being performed via a particular one of these devices can be performed by a different one of these devices, by a combination of these devices, and/or by other devices.

Venue device 310, user device 320, third-party server 350, other mobile devices, LMS server 360, logging server 370, customer service device 380, and server 330 can communicate with one another via a network, such as the Internet 340.

Venue device 310, user device 320, third-party server 350, other mobile devices, LMS server 360, logging server 370, customer service device 380, and server 330 can communicate with one another via one or more networks, such as local area networks (LANs), wide area networks (WANs), cellular telephone networks, and the like. Venue device 310, user device 320, third-party server 350, other mobile devices, LMS server 360, logging server 370, customer service device 380, and server 330 can communicate with one another, at least partially, via one or more near field communications (NFC) methods or other short range communications methods, such as infrared (IR), Bluetooth, WiFi, and WiMax.

When a user wishes to shop for tickets online, sell tickets online, check in to an event venue online, access electronic tickets online, provide location information online, or track tickets online (as examples), the user can open an online ticket seller's website or can access the ticket seller using an application such as app 325. The user can open the ticket seller's website using user device 320, for example. The ticket seller's website can be hosted on ticket server 330, LMS server 360, or on any other server or device.

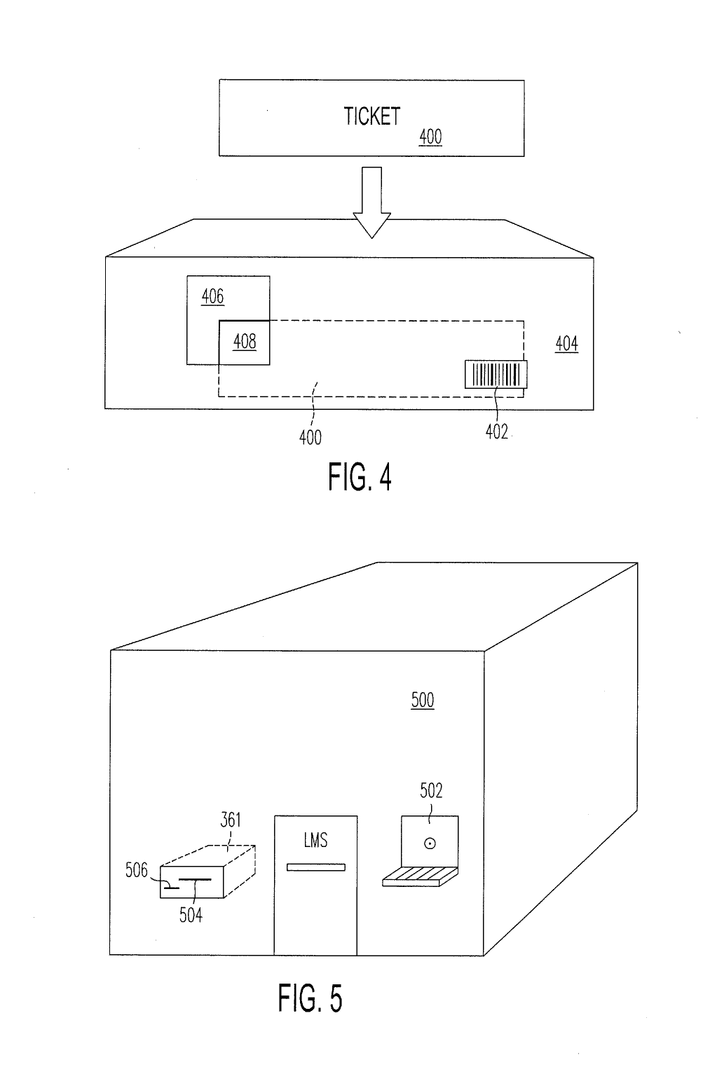

FIG. 4 is a diagram of an illustrative scannable code that can be provided to a seller by, for example, an LMS center according to one embodiment. In the example of FIG. 4, the scannable code is a bar code 402. A code such as bar code 402 can be generated by an LMS server such as LMS server 360 and provided to a seller together with instructions for the seller to send or deliver one or more tickets such as ticket 400 to a particular LMS center location. Bar code 402 may be generated automatically in response to an LMS selection by a seller on a ticket server webpage or using a ticket server application or the generation of bar code 402 may be initiated by agent of an LMS center.

A scannable code such as bar code 402 may be provided together with instructions for including the code with ticket 400 when the ticket is sent or delivered to the LMS center. A scannable code such as bar code 402 may be printed by the seller and attached to the tickets or attached to a package in which the tickets are sent to the LMS center. In the example of FIG. 4, bar code 402 is attached to the outside of an envelope 404 in which ticket 400 can be placed. However, this is merely illustrative. In various embodiments, a scannable code can be attached to the outside of a different type of package in which ticket 400 is include, placed into an envelope or other package in which ticket 400 is included, attached directly to ticket 400 or otherwise clipped, taped, wrapped, or coupled to one or more tickets such as ticket 400.

In some embodiments, envelope 404 may be provided to the seller (e.g., by the LMS center or other agent of a ticket server). In other embodiments, a seller may attach bar code 402 to the seller's own envelope. The seller may be encouraged to provide the tickets to the LMS center in a transparent or partially transparent envelope. For example, envelope 404 may include a transparent portion such as window 406 that allows a portion such as portion 408 of a ticket 400 to be viewed through the window. In this way, an agent or an automatic ticket receipt mechanism at an LMS center can quickly and easily verify that the tickets associated with bar code 402 are included with the bar code upon delivery to LMS.

Bar code 402 may identify a ticket, a listing, a seller, a single ticket or a group of tickets associated with a seller, a single ticket or a group of tickets associated with a particular listing, or other information associated with one or more tickets for sale. Bar code 402 may uniquely identify each ticket or set of tickets from a seller for an event and associate that ticket or set of tickets with a listing on a ticket server website. Bar code 402 may be scanned at the LMS center when the ticket arrives at the LMS center.

FIG. 5 shows a diagram of an illustrative LMS center having a code scanner for scanning scannable codes such as bar code 402. As shown in FIG. 5, a last minute services (LMS) center 500 may include a ticket window 502 and/or a code scanner 361. Code scanner 361 may be provided on an exterior portion of center 500 as shown, may be attached to ticket window 502 or may be provided inside center 500 (as examples). Code scanner 361 may be used to scan a scannable code associated with one or more tickets that are being delivered to LMS center 500.

Code scanner 361 may, according to some embodiments, have an automatic ticket acceptance mechanism 504 and/or a receipt printer 506. Code scanner 361 may also include ticket imaging capabilities. In some embodiments, code scanner 361 may be used to capture an image of tickets that are provided to the LMS center. Ticket images of this type can be displayed on a ticket listing on ticket server 330.

Automatic acceptance mechanism 504 may be used to automatically accept tickets having an attached scannable code that identifies the tickets. In one usage scenario, a ticket seller may arrive at the LMS center after hours and insert an envelope including one or more tickets and a scannable code into automatic acceptance mechanism 504. Mechanism 504 may draw in the envelope, scan the scannable code, verify that the appropriate tickets are included, and transmit ticket receipt information to ticket server 330 and/or logging server 370. In response to receiving scanned code information from code scanner 361, a ticket server may activate an online listing for the tickets.

In some embodiments, envelopes for inserting into mechanism 504 may be provided at LMS center 500. For example, transparent envelopes with slots for each ticket that allow each ticket to be viewed through the exterior of the envelope may be provided. A seller dropping off tickets may be instructed to insert each ticket into the provided envelope so that the ticket is visible, insert a provided scannable code on or within the provided envelope in a location visible to code scanner 361, and insert the provided envelope with the visible tickets and scannable code into automatic acceptance mechanism 504. Mechanism 504 may draw in the transparent envelope, scan the scannable code, capture an image of each ticket, verify that the appropriate tickets are included, and transmit ticket receipt information to ticket server 330 and/or logging server 370 if the appropriate tickets are included. In circumstances in which one or more tickets associated with the scanned code are not visible (e.g., if the tickets are provided in an opaque envelope, one or more tickets are missing, and/or one or more tickets is improperly inserted into the transparent envelope), the customer may be alerted that the activation of a listing for the tickets may be delayed until an agent of the LMS center can verify that the appropriate tickets have been provided to the LMS center.

Printer 506 may be used to print a physical receipt for the tickets when the scannable code is scanned by code scanner 361. Code scanner 361, acceptance mechanism 504, and receipt printer 506 may operate in a fully automatic mode or one or all of code scanner 361, acceptance mechanism 504, and receipt printer 506 can be operated by an agent of the LMS center 500 and/or a seller or a buyer. In another usage scenario, a ticket or set of tickets can be delivered to the agent of the LMS center along with a scannable code that has been provided to a seller. The LMS agent can use code scanner 361 to scan the scannable code, thereby activating a ticket listing. If desired, the LMS agent can use printer 506 to print a receipt for the received tickets to be kept in a file at the LMS center and/or to be provided to a seller or other person who is delivering the tickets.

In other usage scenarios, code scanner 361 may be used to scan a bar code associated with the tickets and the corresponding listing when the tickets are sent for delivery to a buyer, sent to an event venue will call center, or picked up by a buyer.

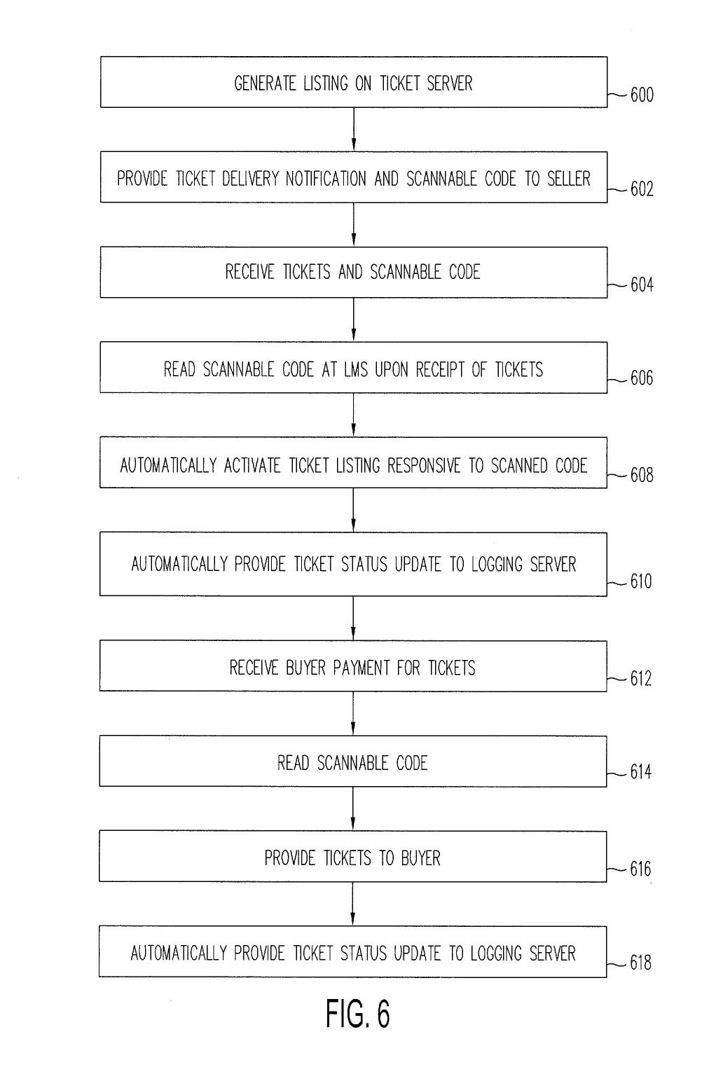

Various operations that may be performed by a system such as system 100 of FIG. 1 and/or any or all of the servers and/or devices of FIG. 3 during a ticket sales, purchase, and tracking operation using scannable codes associated with one or more ticket listings are shown in FIG. 6.

At step 600, a listing of one or more tickets for sale may be generated on a ticket server. For example, a seller may use the ticket server to create a listing for one or more tickets for sale for a ticketed event. The listing may include a selected LMS option.

At step 602, a ticket delivery notification and a scannable code associated with the listing may be provided to the seller. For example, LMS (e.g., an LMS server such as LMS server 360) may generate the scannable code specific to the listing (e.g., specific to the listed tickets), provide the scannable code to the seller, and instruct the seller to send or deliver the tickets to a particular LMS center with the scannable code attached. The provided scannable code may be a printable code that the seller can print at home and provide with the tickets (e.g., by affixing the printed scannable code to an envelope or other package containing the tickets).

At step 604, the tickets and the attached, scannable code may be received (e.g., at the particular LMS center). The tickets and attached scannable code may be received when the seller drops off the tickets or when a courier delivers the tickets (as examples).

At step 606, the scannable code may be read (scanned) at the LMS center upon receipt of the tickets. The scannable code may be read automatically or an agent of the LMS center may use a code scanner to scan the scannable code. In some embodiments, the received tickets can also be imaged at the LMS center.

At step 608, responsive to the scanned code, the LMS server and/or the ticket server may automatically activate the ticket listing. For example, a ticket listing that uses LMS may remain pending until the physical tickets are available at the LMS center. The scanned code may therefore be used as an indicator that the tickets are available at the LMS center, thereby avoiding any delays associated with an agent opening mail and/or determining which listing the tickets correspond to. One or more ticket images may also be added to the listing.

At step 610, a ticket status update may be provided to a logging server (e.g., responsive to the scanned code). The ticket status update may include information indicating the time, date, location, scanner, or other information associated with the arrival of the tickets at the LMS center.

At step 612, a payment may be received from a buyer of the tickets. The payment may be received directly at the LMS center, online through the ticket server, or through an associated third party server such as a payment provider server.

At step 614, the scannable code may be read again in association with the ticket sale and/or delivery of the tickets to the buyer.

At step 616, the tickets may be provided to the buyer. Depending on the time until the start of the event, the tickets may be provided directly to a buyer picking up the tickets, sent to the buyer using a courier service, or provided to an event venue will call center (as examples).

At step 618, an additional ticket status update may be provided to the logging server and/or the ticket server based on the additional scan of the scannable code.

In this way, the status of tickets to be sold using LMS can be closely tracked and updates to the ticket status and/or the ticket listing can be efficiently processed to avoid delays in activating listings and/or to avoid errors in the ticket listing or other errors in the ticket sale and purchase process.

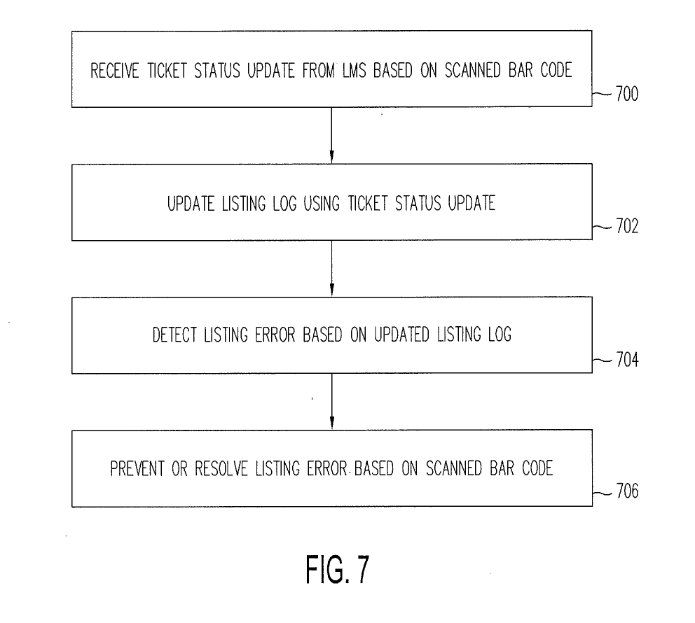

Illustrative steps that may be included in an example usage scenario in which a ticket listing error is prevented or avoided using a scannable code associated with the tickets are shown in FIG. 7.

At step 700, a ticket status update may be received (e.g., by a ticket server and/or a logging server of the type described herein) from an LMS center (e.g., from an LMS server) based on a scanned code such as a bar code. For example, a seller or an LMS agent may scan a scannable code such as a bar code at the LMS center when listed tickets associated with the scannable code are received at the LMS center.

At step 702, a listing log associated with the listed tickets may be updated based on the scanned code. For example, a ticket server and/or a logging server may add an entry to a listing log for the ticket listing that indicates when and where the tickets were received and/or other information associated with the receipt of the tickets.

At step 704, a listing error may be detected based on the listing log. For example, the ticket server may detect that the listing is active and should be inactive or pending, that the listing is inactive or pending and should be active, that the listing shows a number of tickets for sale that is different from the number of tickets received at the LMS center, or that a seller is attempting to update a listing in a way that is inconsistent with the current ticket status based on the scanned bar code.

At step 706, the ticket server may prevent or resolve the listing error based on the scanned bar code. For example, the ticket server may automatically update the number of available tickets, provide an error alert to the seller that an erroneous listing update request has been received, activate a listing, inactivate a listing, or otherwise update a ticket listing based on the scanned code.

In this way, errors in ticket listings can be reduced or eliminated, thereby increasing the efficiency and efficacy of an online ticket server that provides last minute services for ticket sale, purchase, and delivery.

The processes described in connection with FIGS. 6 and 7 may be performed in any suitable order and repeated any suitable number of times to facilitate ticket tracking and error prevention and/or resolution operations associated with the listing, sale, and/or purchase of one or more tickets.

Although the foregoing invention has been described in detail by way of illustration and example for purposes of clarity and understanding, it will be recognized that the above described invention may be embodied in numerous other specific variations and embodiments without departing from the spirit or essential characteristics of the invention. Various changes and modifications may be practiced, and it is understood that the invention is not to be limited by the foregoing details, but rather is to be defined by the scope of the claims.

What is claimed is:

1. A system, comprising:
a hardware memory configured to store a listing of tickets to be sold for a ticketed event;
a code scanner at a location associated with the ticketed event; and
one or more processors coupled to the hardware memory and communicatively connected to the code scanner, wherein the one or more processors are configured to:
generate the listing of tickets for a seller;
receive a last minute services request from the seller;
generate a scannable code associated with and separate from the tickets;
provide the scannable code associated with the tickets to the seller;
receive information contained in the scannable code when the tickets are provided to a last minute services center and the code is scanned by the code scanner; and
update the listing based on the information from the scannable code.

2. The system defined in claim 1, wherein the one or more processors are further configured to activate the listing based on the scannable code to update the listing.

3. The system defined in claim 2, wherein the one or more processors are further configured to provide instructions to the seller to provide the tickets to the last minute services center together with the scannable code.

4. The system defined in claim 1, wherein the one or more processors are further configured to hold the tickets for resale at the last minute services center.

5. The system defined in claim 1, wherein the code scanner comprises an automatic acceptance mechanism configured to automatically receive the tickets and the scannable code when the tickets are provided to the last minute services center.

6. The system defined in claim 1, wherein the code scanner is further configured to capture an image of the tickets when the tickets are provided to the last minute services center.

7. The system defined in claim 6, wherein the one or more processors are further configured to add the image of the tickets to the listing.

8. A method, comprising:
generating, electronically by one or more processors, a listing of tickets for a seller;
receiving, electronically by the one or more processors, a last minute services request from the seller;
generating, electronically by the one or more processors, a scannable code associated with and separate from the tickets;
providing, electronically by the one or more processors, the scannable code associated with the tickets to the seller;
receiving, electronically by the one or more processors, information contained in the scannable code when the tickets are provided to a last minute services center and the code is scanned by a code scanner at a location associated with the ticketed event; and
updating, electronically by the one or more processors, the listing based on information from the scannable code.

9. The method defined in claim 8, further comprising receiving the tickets at the last minute services center together with the scannable code.

10. The method defined in claim 8, wherein the receiving of the tickets comprises receiving the tickets automatically using an automatic acceptance mechanism at the last minute services center.

11. The method defined in claim 8, further comprising generating, electronically by the one or more processors, the scannable code responsive to the receiving of the last minute services request.

12. The method defined in claim 8, further comprising printing a receipt at the last minute services center responsive to the receiving of the scannable code.

13. The method defined in claim 8, wherein the scannable code comprises a bar code.

14. The method defined in claim 8, further comprising:
detecting a listing error in the listing using the scannable code; and
resolving the listing error based on the scannable code.

15. A non-transitory machine-readable medium having a plurality of machine-readable instructions which, when executed by one or more processors of a server, are adapted to cause a server to perform a method comprising:
generating a listing of tickets for a seller;
receiving a last minute services request from the seller;
generating a scannable code associated with and separate from the tickets;
providing the scannable code associated with the tickets to the seller;
receiving information contained in the scannable code when the tickets are provided to a last minute services center and the code is scanned by a code scanner at a location associated with the ticketed event; and
updating the listing based on information from the scannable code.

16. The non-transitory machine-readable medium defined in claim 15, wherein the method further comprises receiving a payment from a buyer for the tickets.

17. The non-transitory machine-readable medium defined in claim 16, wherein the method further comprises receiving the scannable code when the tickets are provided to the buyer.

18. The non-transitory machine-readable medium defined in claim 15, wherein the method further comprise generating the scannable code responsive to the receiving of the last minute service request.

19. The non-transitory machine-readable medium defined in claim 15, wherein the method further comprises instructing a receipt printer at the last minute services center to print a receipt responsive to the receiving of the scannable code.

20. The non-transitory machine-readable medium defined in claim 15, wherein the scannable code comprises a quick response code.
